(19) United States
(12) Patent Application Publication
(10) Pub. No.: US 2011/0066618 A1
(43) Pub. Date: Mar. 17, 2011

(54) QUERY TERM RELATIONSHIP CHARACTERIZATION FOR QUERY RESPONSE DETERMINATION

(75) Inventors: Borkur Sigurbjornsson, Barcelona (ES); Vanessa Murdock, Barcelona (ES); Roelof van Zwol, Barcelona (ES); Maarten Clements, Delft (NL)

(73) Assignee: Yahoo! Inc., Sunnyvale, CA (US)

(21) Appl. No.: 12/558,924

(22) Filed: Sep. 14, 2009

(51) Int. Cl. G06F 17/30; G06F 17/28

(52) U.S. Cl. 707/739; 707/E17.015

(57) ABSTRACT

Methods, apparatuses, and systems are provided to determine a response to a user submitted query based, at least in part, on a relationship between and/or among a plurality of terms of the query.

### BACKGROUND

1. Field

The subject matter disclosed herein relates to characterization of relationships between and/or among query terms to determine a query response.

2. Information

Information in the form of electronic data continues to be generated or otherwise identified, collected, stored, shared, and analyzed. Databases and other like data repositories are common place, as are related communication networks and computing resources that provide access to such information. As one example, the World Wide Web provided by the Internet continues to grow with seemingly continual addition of new information.

Computing resources enable users to access a wide variety of information in the form of media content including documents, images, video, audio, and software applications to name a few. As one example, media content in the form of web documents (e.g., web pages) may be accessed on the Internet's World Wide Web via a networked computing resource. As another example, media content may reside locally at a computing resource where it may be accessed by the user without necessarily requiring network interaction with other computing resources.

To provide access to such information, tools and services have been provided which allow for copious amounts of information to be searched through. For example, service providers may allow for users to search the World Wide Web or other like networks using search engines. Similar tools or services may allow for one or more databases or other like data repositories to be searched. However, with so much information being available, there is a continuing need for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram of an example computing environment according to one implementation.

FIG. 2 is a flow diagram illustrating an example process for determining a response to a query based, at least in part, on a relationship between and/or among a plurality of terms of the query according to one implementation.

FIG. 3 is a flow diagram illustrating an example process for characterizing a relationship between and/or among a plurality of terms of a query according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill may not be described in substantial detail so as not to obscure claimed subject matter.

Through the use of the web, users may access an immense quantity of information. However, because there is so little organization to the web, at times it may be extremely difficult for a user to locate particular information that may be of interest to the user. To address this problem, a resource known as a “search engine” may be employed to index the information and provide an interface that enables a user to search the indexed information, for example, by submitting one or more terms in a query.

Some implementations of a search engine may analyze information by determining relevant items for identifying the relevancy of such information. Relevant items may include, for example, terms (e.g., keywords) utilized within a title of a particular media content item, a URL or other network address identifier for accessing the media content item, terms within a body of the media content item itself, or as metadata associated with the media content item. As a non-limiting example, terms representing the phrase “car sales” in association with a media content item may indicate that the subject matter of the media content item is related to car sales. A search engine may store such relevant items in a searchable index. Yet, searching such vast amounts of information may be made more difficult due to its dynamic nature. For example, both media content and search queries may be changing rapidly. One issue for improving search is how to better serve user information needs.

According to one implementation, a computing environment is described which comprises a computing platform capable of responding to user initiated queries based, at least in part, on a specificity relationship between and/or among a plurality of terms of the query. This relationship may indicate a semantic specificity between and/or among a plurality of terms of the query, for example. Unless specifically stated otherwise, “semantic specificity,” as used herein, relates to a degree to which a term is specific or general in its meaning relative to other terms. Such semantic specificity may be expressed as a relative hierarchy or ordering that exists between respective meanings of two or more terms. As a non-limiting example, it will be appreciated that the term “dog” is semantically more specific and therefore exhibits greater semantic specificity than the term “animal”, because a dog is a specific type of animal.

For at least some domains to which a query may be directed, semantic specificity of query terms may be strongly related to an importance of the terms to represent the information need of a user. Accordingly, application to a query of a relationship between and/or among a plurality of terms of the query may be used to vary an influence of the term on a result for the query. For example, the term “dog” may be associated with a greater weighting factor than the term “animal” since the term “dog” is semantically more specific than the term “animal”. Hence, application of relationships between and/or among query terms may help to improve the relevance of the result for a particular query.

According to one implementation, a computing environment is described which comprises a computing platform capable of characterizing a relationship indicative of a semantic specificity between and/or among a plurality of terms of a query by application of pair-wise comparisons. To quantify a pair-wise relationship between two terms, a computing platform may identify whether the pair-wise relationship between the two terms exhibits one of three classes of relationships. For example, term pairs may be characterized as at one of: (1) semantically unrelated or incomparable, (2) similar semantic specificity, or (3) one term is semantically more or less specific than the other term.

Furthermore, specificity and similarity measures may be combined in a machine learned approach to classify the term pairs in any of these relationship classes. In particular the computing platform may be adapted to enable the comparison of a pair of terms, and (1) predict the type of semantic relationship between the two terms, and (2) provide a weighing of the terms which may be interpreted by a search engine to determine a result for the query.

However, specificity of a term may be difficult to identify in some scenarios. For example, some approaches for identifying term specificity may ignore semantic relationships among terms by applying a statistical analysis of the frequency with which a particular term occurs within the information being analyzed. Such statistical analysis for identifying term specificity that ignores semantic relationships between and/or among terms may provide less relevant results in some scenarios. For example, specificity of a term may be dependent on a variety of factors in addition to a frequency with which the term occurs within the information. A very specific term may occur frequently in information if that term happens to be popular in the community that created the information. For example, the terms “html” and “knitting” may be considered to be equally specific as both describe a method of constructing objects (e.g., web pages and clothing, respectively). However, the term “html” may occur more frequently than the term “knitting” in some information domains (e.g., web pages on the Internet) as a result of the familiarity of the community with the term “html” in contrast to “knitting”. Yet in other information domains, such as an image library, the term “knitting” may occur more frequently than the term “html”. Hence, a frequency with which a particular term occurs in information may be highly dependent on domain. As such, term frequency may not be the sole reliable source to derive term specificity for all scenarios.

Accordingly, the ordering of terms according to semantic specificity may provide more relevant results if the terms can be compared in the same domain. For example, given a pair of terms, a computing platform may be further adapted to apply a learning process that was trained on a relevant domain of terms to predict which relationship classification applies, and may produce a score to reflect its confidence in the prediction. The score may be used to weigh the two terms and associate a weighting factor with one or more of the terms to be used by the search engine. Such machine learned predictions of semantic specificity relationships between query terms within a particular domain may improve result accuracy and relevance. Hence, learning may be domain specific in some implementations. The ability for the computing platform to reason about the relationship between query terms may be useful in a number of applications, such as query term weighting, query expansion, and query/tag recommendations.

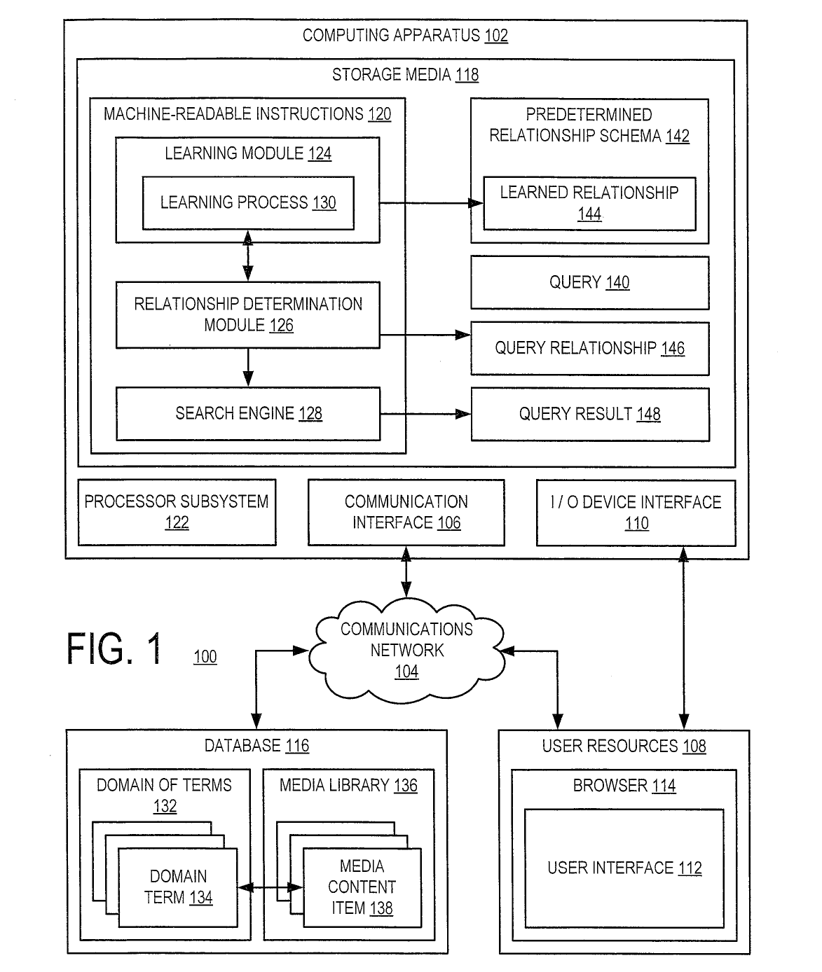

FIG. 1 is a schematic block diagram of an example computing environment 100 according to one implementation. Computing environment 100 may include a computing device/platform such as computing apparatus 102. Unless specifically stated otherwise, a “computing device” or a “computing platform,” as used herein, may refer to various stationary and/or mobile computing devices/platforms, including network servers, desktop computers, laptop computers, workstations, digital media players, personal digital assistants, and mobile telephones to name a few.

The context in which computing apparatus 102 may be implemented may vary. As a non-limiting example, computing apparatus 102 may be implemented as a network server in conjunction with a public network (e.g., the Internet) and/or a private network (e.g., an Intranet). As another non-limiting example, computing apparatus 102 may be deployed as a stand-alone computing device without necessarily requiring network interaction.

Computing apparatus 102 may be operatively coupled to a communications network 104. In FIG. 1, communications network 104 is representative of one or more communication links, processes, and/or resources configurable to support the exchange of data between and/or among computing apparatus 102, database 116, and user resources 108, as well as among other computing platforms and/or resources. By way of example but not limitation, communications network 104 may include wireless and/or wired communication links, telephone or telecommunications systems, data buses or channels, optical fibers, terrestrial or satellite resources, local area networks, wide area networks, personal area networks, intranets, the Internet, routers or switches, and the like, or any combination thereof. Communications network 104 may comprise a digital electronic communication network in at least one implementation. Computing apparatus 102 may further include a communication interface 106 to receive electrical digital signals representative of information from communications network 104 and transmit electronic digital signals representative of information to communications network 104.

A user (e.g., a human end user) may utilize user resources 108 to access, communicate with, and/or otherwise interact with computing apparatus 102. In at least some embodiments, user resources 108 may communicate with computing apparatus 102 via communications network 104. In other embodiments, user resources 108 may communicate with computing apparatus 102 via an input/output device interface 110. Hence, it will be appreciated that the implementation of user resources 108 may vary depending on the context in which computing apparatus 102 is implemented. For example, where computing apparatus is implemented as a network server or other suitable network resource, user resources 108 may comprise a second computing device/platform that enables a user to interact with computing apparatus 102 via communications network 104. It will be appreciated that computing environment 100 may further include any number of user resources, which may communicate with computing apparatus 102 as described with reference to user resources 108.

User resources 108 may include a user interface 112 comprising one or more input devices and/or output devices for enabling a user to communicate with computing apparatus 102. Input devices may include one or more of a keyboard, a touch sensitive graphical display, a microphone, a computer mouse or other suitable pointing device, etc. Output devices may include one or more of a graphical display, a loudspeaker, a printer, a haptic feedback device, etc. In at least some embodiments, user resources 108 may execute a browser 114 or other suitable software application/program for facilitating user interaction with computing apparatus 102. For example, browser 114 may be used by a user to facilitate the access and/or retrieval of media content items from computing apparatus 102 and/or database 116.

Unless specifically stated otherwise, “media content,” as used herein, may refer to encoded information and/or electrical digital signals representative of one or more of the following: documents (e.g., text documents, web documents), images (e.g., pictures, graphical representations, static imagery), video (e.g., movies, animations, dynamic imagery), audio (e.g., music, audio books, podcasts), and executable code (e.g., software applications) to name a few. Similarly, a “media content item,” as used herein, may refer to encoded information and/or electrical digital signals representative of an individual document, image file, video file, audio file, executable program, or portion thereof. It will be appreciated that media content may be user created or may be obtained from third-party media content providers.

A user may utilize user resources 108 to interact with computing apparatus 102 and/or database 116 in a number of ways. As one example, a user may desire to search for media content related to a certain topic of interest. Such a user may initiate a search for media content by submitting a query to computing apparatus 102 via user resources 108. As another example, a user may desire to assign informational tags to media content (e.g., as metadata and/or by a relational database) in order to improve subsequent searching and classification of media content. Such a user may assign informational tags to one or more media content items by submitting the informational tags to computing apparatus 102 or database 116 via user resources 108, where the informational tags may be assigned to appropriate media content items indicated by the user. As yet another example, a user may desire to receive recommended terms for expanding a search query or expanding a range of informational tags assigned to the media content. Such a user may submit a query to computing apparatus 102 via user resources 108 that identifies one or more terms for which term expansion is desired. Further still, a user may desire to observe a graphical representation of a relationship between and/or among the informational tags of a particular domain of media content items. Such a user may direct a query to a particular desired domain of terms represented by the informational tags by submitting the query which identifies the desired domain to computing apparatus 102 via user resources 108. An example query that has been received at computing apparatus 102 from user resources 108 is depicted as query 140. In each of the above examples, computing apparatus 102 may transmit a result for the query to the user resources that submitted the query where the result may be presented to the user.

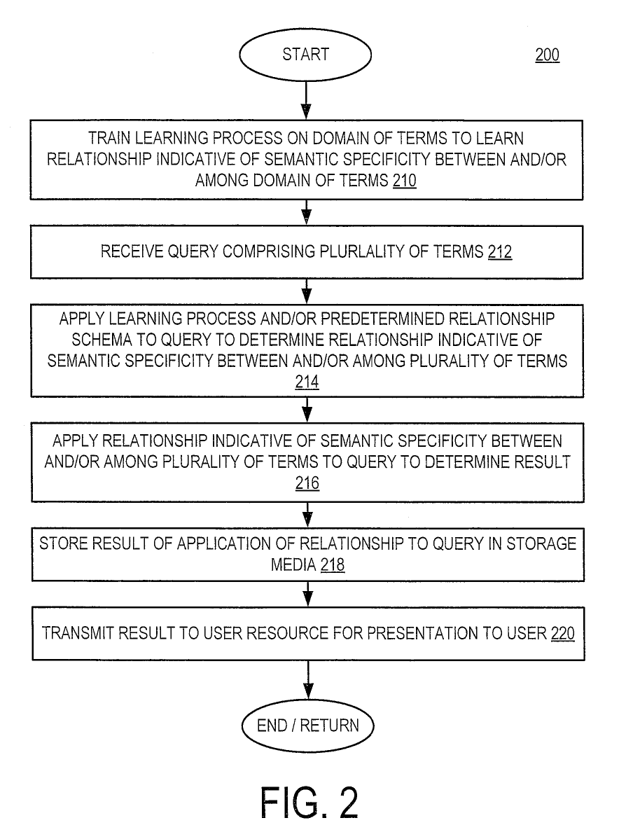

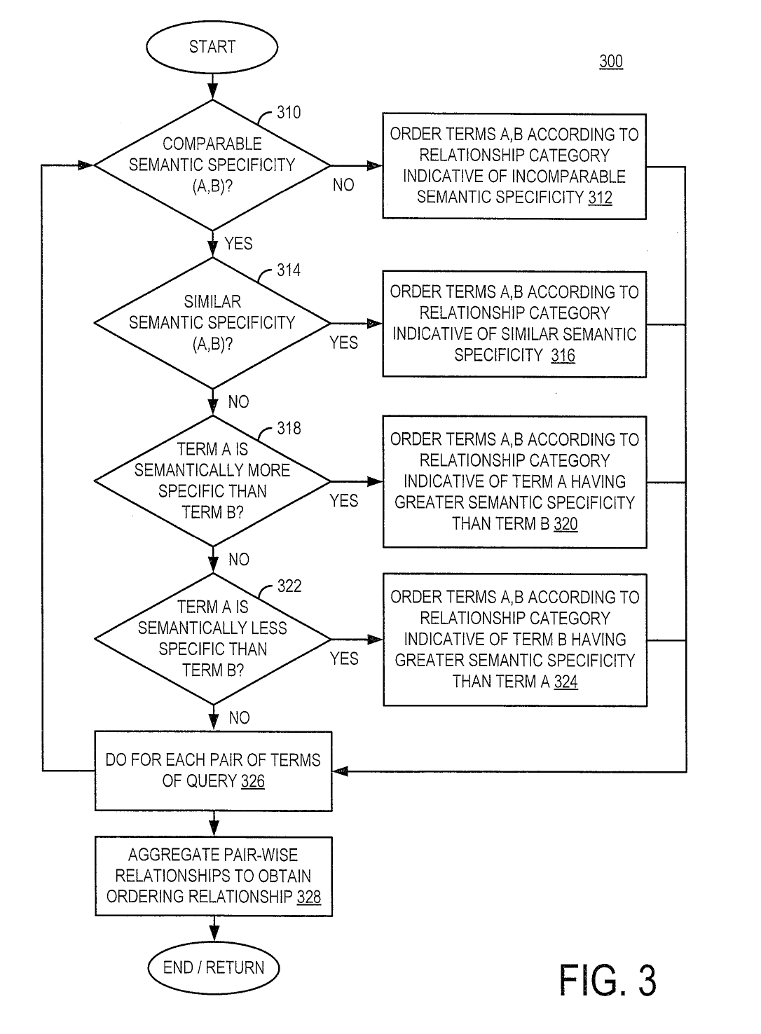

Computing apparatus 102 may include storage media 118 that comprises machine-readable instructions 120 stored thereon that, in response to being executed by a processing subsystem 122, directs processing subsystem 122 to perform one or more of the various methods, processes, and operations described herein. For example, machine-readable instructions 120 may direct processing subsystem 122 to perform one or more of the operations described with reference to flow diagram 200 of FIG. 2 and flow diagram 300 of FIG. 3.

Processing subsystem 122 is representative of one or more circuits configurable to perform at least a portion of a data computing procedure, process, and/or operation. By way of example but not limitation, processing subsystem 122 may include one or more processors, controllers, microprocessors, microcontrollers, application specific integrated circuits, digital signal processors, programmable logic devices, field programmable gate arrays, and the like, or any combination thereof. While storage media 118 is illustrated in FIG. 1 as being separate from processing subsystem 122, it should be understood that all or part of storage media 118 may be provided within or otherwise co-located/coupled with processing subsystem 122. It will also be appreciated that the various components of computing apparatus 102, including processing subsystem 122, storage media 118, communication interface 106, and input/output device interface 110 may communicate with each other via a data bus.

Storage media 118 may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, storage media 118 or portions thereof may be operatively receptive of, or otherwise configurable to couple to, computing apparatus 102.

According to an embodiment, one or more portions of storage media 118 may store signals representative of data and/or information as expressed by a particular state of storage media 118. For example, an electronic signal representative of data and/or information may be “stored” in a portion of storage media 118 (e.g., memory) by affecting or changing the state of such portions of storage media 118 to represent data and/or information as binary information (e.g., ones and zeros). As such, in a particular implementation, such a change of state of the portion of storage media 118 to store a signal representative of data and/or information constitutes a transformation of storage media 118 to a different state or thing.

Machine-readable instructions 120 may comprise one or more programs or software modules. As a non-limiting example, machine-readable instructions 120 may comprise a learning module 124, a relationship determination module 126, and a search engine 128.

Learning module 124 may be adapted to train a learning process 130 on a domain of terms to learn a relationship indicative of semantic specificity between and/or among the domain of terms. As one example, a domain of terms 132 may include one or more terms assigned to or associated with media content items as informational tags. Database 116 may include a media library 136 containing media content items such as media content item 138 that is assigned one or more terms such as domain term 134 of domain of terms 132. For example, media content item 138 may comprise an image of a dog and domain term 134 may comprise an assigned term such as “dog”, “animal”, or other suitable term that describes the image content. As another example, domain of terms 132 may include terms that comprised previously submitted queries (e.g., query logs), whereby domain term 134 may have formed at least part of one or more queries received at the computing apparatus.

Learning module 124 apply any suitable algorithm to learning process 130 to facilitate training. As a non-limiting example, learning module 124 may apply an algorithm to learning process 130 that considers both term specificity and term similarly. Term specificity may be determined, for example, using a variety of methods that consider one or more of term frequency, vocabulary growth, term entropy, simplified clarity score, and sub-super methods. Term similarity may be determined using a variety of methods including co-occurrence methods and/or context methods. Co-occurrence methods may be used, for example, to derive a similarity metric between two terms by considering one or more functions, including joint probability, cosine similarity, and the Jaccard coefficient. Context methods may consider, for example, one or more of ranked list similarity, KL-divergence, and sub-super sum functions. As a non-limiting example, learning module 124 may apply a combination of sub-super, entropy, and simplified clarity score functions to train the learning process on a domain of terms.

Term frequency (e.g., document frequency) may refer to a frequency at which a particular term occurs or is present in a particular information domain. For example, a document frequency of a particular term may be represented by a probability that a random media content item of a domain of media content items is associated with the particular term. Vocabulary growth may refer to a change in a size of a vocabulary of unique terms of the domain. A size of a vocabulary related to a single term may be used as a measure of specificity. Term entropy may refer to a number of terms co-occurring with a particular term (e.g., in association with a common media content item) within the domain. A high entropy of co-occurring terms may suggest that the particular term is a representative of a very broad concept. Simplified clarity score may refer to a probability of observing a particular term for a given query or a probability of observing a particular media content item associated with a term given the query equal for all media content items that are associated with the term. Clarity score can be used to estimate a difficulty of a particular query for a retrieval system, whereby query difficulty may be related to specificity of a query term such that a more specific query term is easier for the retrieval system to answer. Sub-super may refer to an assumption that if two terms of a domain can be ordered by specificity, the subsets of the more specific term will also be subsets of the more general term, but the converse of this relationship is not necessarily assumed. For example, subsets of the term “paris” (e.g. louvre, eiffel, notredame) also co-occur with the term “france”, but not all subsets of the term “france” co-occur with the term “paris” (e.g. toulouse, bordeaux, lyon). Joint probability may refer to the probability that two tags co-occur in association with a randomly selected media content item. Cosine similarity may refer to the cosine of the angle between two probability vectors. The Jaccard coefficient may refer to the co-occurrence probability of two terms, normalized by the union of both individual occurrence probabilities. KL-Divergence may be determined between two probability distributions of a discrete random variable to compute, for example, the KL-Divergence on the top 100 conditional probabilities of a pair of terms. KL-Divergence may be used to find terms in a domain that yields the optimal disambiguation of the query. Sub-super sum may refer to the sum of two sub-super relations between two terms. The difference in directed sub-super scores may provide an indication of similar specificity, while the sum of both directed sub-super scores indicates if the two terms are strongly related.

Learning module 124 may be further adapted to determine a learned relationship 144 indicative of semantic specificity between and/or among the domain of terms responsive to training of the learning process, whereby learned relationship 144 may be stored in storage media 118 or in database 116. A predetermined relationship schema 142 may comprise and/or be established at least in part by learned relationship 144 obtained from learning process 130. Predetermined relationship schema 142 may be referenced by relationship determination module 126 to determine a relationship between and/or among terms of a query. In some embodiments, learned relationship 144 may be one of a plurality of learned relationships of predetermined relationship schema 142 where each learned relationship is associated with the training of learning process 130 on a different domain of terms.

Relationship determination module 126 may be adapted to apply learning process 130 and/or predetermined relationship schema 142 including learned relationship 144 to a query to determine a relationship indicative of semantic specificity between and/or among a plurality of terms of the query. Learning module may be further adapted to store the relationship in storage media 118 as depicted by query relationship 146. Query relationship 146 may be referenced by search engine 128 while applying the relationship to the query to determine a result.

Search engine 128 may be adapted to apply to the query the relationship indicative of semantic specificity between and/or among the plurality of terms to determine a result. For example, search engine 128 may be adapted to reference query relationship 146 and determine a result that is based, at least partially, on the application of the relationship to the query. The result may be stored at storage media 118 as indicated by query result 148 and/or may be transmitted to user resources 108 for presentation to the user.

It will be appreciated that in alternative implementations, one or more of learning module 124, relationship determination module 126, and search engine 128 may be provided by separate and/or independent computing devices/platforms that communicate with each other via communications network 104. Similarly, it will be appreciated that database 116 may be stored in storage media 118 of computing apparatus 102 in some implementations, while in other implementations database 116 may be provided by one or more separate and/or independent computing devices/platforms that communicate with computing apparatus via communications network 104.

FIG. 2 is a flow diagram 200 illustrating an example process for determining a response to a query based, at least in part, on a relationship between and/or among a plurality of terms of the query according to one implementation. It will be appreciated that the processes depicted by flow diagram 200 may be controlled and/or directed by execution of instructions stored on a storage medium by a processor to result in one or more of the described operations.

Beginning at operation 210, a learning process may be trained on a domain of terms to learn a relationship indicative of semantic specificity between and/or among at least a portion of terms in the domain of terms. In the context of computing environment 100 of FIG. 1, operation 210 may be performed at least in part responsive to execution of learning module 124 by processing subsystem 122. Training of the learning process may be performed on any suitable number of domains or sub-domains to which queries may be directed by users.

A query comprising a plurality of terms may be received at operation 212. As one example, the query may comprise a search query submitted by a user (e.g., via a user resource). In the context of computing environment 100 of FIG. 1, processing subsystem 122 of computing apparatus 102 may be programmed with instructions comprising relationship determination module 126 to obtain one or more electrical digital signals representing the query that may be received at communication interface 106 or at input/output device interface 110 from user resources 108. The query may be stored at computing apparatus 102 in storage media 118. The plurality of terms of the query may include any suitable number of terms. As a non-limiting example, a query may comprise the three following terms: “safari”, “impala”, and “wildlife”.

In at least some embodiments, a query may be directed by a user to a particular domain. For example, a user may desire to search through a particular subset of media content items of a media library, in which case the user may direct the query to the subset of media content items. As a non-limiting example, the user may direct the query to a subset of images of an image library that includes only images created by the user to the exclusion of images created by other users. In this context, the domain of terms may comprise informational tags assigned to the subset of images that the user created.

At operation 214, a relationship indicative of semantic specificity between and/or among the plurality of terms of the query may be determined. In at least some embodiments, this relationship may be determined by applying a learning process that was trained at operation 210 and/or a predetermined relationship schema to the plurality of terms of the query received at operation 212. In the context of computing environment 100 of FIG. 1, instructions comprising relationship determination module 126 may be executed by processing subsystem 122 to obtain and apply the learning process and/or predetermined relationship schema to the plurality of terms of the query to determine the relationship indicative of semantic specificity between and/or among the plurality of terms.

In at least some embodiments, the relationship may be determined as an ordering relationship where each term of the plurality of terms is ordered according to the term's semantic specificity relative to the other terms of the query. As a non-limiting example, an ordering relationship that is determined at operation 214 may indicate that a first term “impala” of a query is semantically more specific than a second term “wildlife” of the query, because an impala is a specific type of wildlife. Conversely, the ordering relationship may indicate that the second term “wildlife” is semantically less specific (e.g., semantically more general) than the first term “impala”.

In at least some embodiments, the determination of the relationship between and/or among the plurality of terms may include use of pair-wise comparisons of query terms to identify pair-wise relationships whereby each pair of terms of the query is classified into one of a plurality of relationship categories or classifications. Use of pair-wise comparison of terms will be described in greater detail with reference to flow diagram 300 of FIG. 3. Briefly, however, a pair-wise comparison may be performed for pairs of terms of a query by judging whether semantic specificity of a first term of the pair of terms is greater than, less than, similar to, or incomparable to a second term of the pair of terms. In this way, a pair-wise comparison between each term and the other remaining terms of the query may be performed to establish an ordering relationship between and/or among the plurality of terms according to semantic specificity.

In at least some embodiments, a relationship indicative of semantic specificity between and/or among the plurality of terms may be represented by associating a respective weighting factor with individual terms of the query. The weighting factor associated with a particular term may be correlated with and based, at least in part, on the term's semantic relationship relative to other terms of query. For example, terms exhibiting greater semantic specificity in relation to other terms of the query may be associated with a greater weighting factor than terms exhibiting lesser semantic specificity. These weighting factors associated with query terms may be referenced by a search engine to determine a result for the query. In this way, an influence of a first term of a query upon a result of the query may be increased relative to an influence of a second term of the query if the first term exhibits a greater semantic specificity than the second term.

At operation 216, a relationship indicative of semantic specificity between and/or among the plurality of terms may be applied to a query to determine a result. In the context of computing environment 100 of FIG. 1, processing subsystem 122 of computing apparatus 102 may be programmed with instructions comprising search engine 128. Search engine 128 may apply to the query one or more electrical digital signals representative of the relationship indicative of semantic specificity between and/or among the plurality of terms of the query determined at operation 214. For example, search engine 128 may be adapted to reference and apply weighting factors associated with terms of the query to those terms to determine a result. As a non-limiting example, a term associated with a higher weighting factor may exhibit greater influence upon the result determined by the search engine than a term associated with a lower weighting factor.

The result determined at 216 may comprise a variety of information. In at least some embodiments, the result may indicate a hierarchical order of a plurality of result items. For example, where a user directs the query to a media library comprising a plurality of media content items, the result may indicate an ordered list of result items indicating or comprising the media content items that are relevant to the query. In at least some embodiments, the list of result items may comprise links (e.g., URL hyperlinks) to respective media content items stored at a network resource (e.g., database 116 of FIG. 1). A user may access a particular media content item by selecting a corresponding link of the list of result items.

In at least some embodiments, the result may indicate one or more recommended terms that each exhibits either a greater semantic specificity or a lesser semantic specificity than at least one term of the query. As a non-limiting example, where the query includes the term “dog”, the result may indicate a first recommended term “animal” exhibiting a lesser semantic specificity than the term “dog” and may further indicate a second recommended term “bulldog” exhibiting a greater semantic specificity than the term “dog”. In this way, the result may provide term expansion to aid the user in refinement of subsequent queries or serve as suggestions for additions or amendments to informational tags that may be assigned to media content items.

In at least some embodiments, the result may indicate a graphical representation of the relationship indicative of semantic specificity between and/or among the plurality of terms determined at operation 214 and/or between and/or among terms of a domain to which the query was directed by the user. For example, a user may desire to be presented with a graphical representation of the informational tags associated with media content items of a particular domain or query terms of a plurality of queries that were previously directed at the domain.

The result of the application of the relationship to the query may be stored in a machine readable storage media at 218 where it may be later retrieved and/or transmitted to a user. For example, one or more processors of computing apparatus may be programmed with instructions to store in memory one or more electrical digital signals representative of the result of application of the one or more electrical digital signals representative of the relationship determined at operation 214 to the one or more electrical digital signals representative of the query received at operation 212.

The result of application of the relationship to the query may be transmitted to a user resource for presentation to the user. In the context of computing environment 100 of FIG. 1, processing subsystem 122 of computing apparatus 102 may be programmed with instructions comprising search engine 128 to transmit one or more electrical digital signals representative of the result to user resources 108. In turn, user resources 108 may be adapted interpret the one or more electrical digital signals representative of the result in order to present the result to the user, for example, by displaying the result on a graphical display of user interface 112. As previously described, the result may comprise a variety of information. For example, the result may indicate a hierarchical order of relevant result items (e.g., media content items), recommended terms that exhibit a greater or lesser semantic specificity than the query terms, and/or graphical representations of the relationship between and/or among the query terms.

FIG. 3 is a flow diagram 300 illustrating an example process for characterizing a relationship between and/or among a plurality of terms of a query according to one implementation. It will be appreciated that the processes depicted by flow diagram 300 may be controlled and/or directed by execution of instructions stored on a storage medium by a processor to result in one or more of the described operations. Flow diagram 300 provides greater detail of one implementation of operation 214 of FIG. 2 in which a pair-wise comparison of terms may be used to identify pair-wise relationships whereby each pair of terms of a query is classified into one of a plurality of relationship categories or classifications.

Beginning at operation 310, it may be judged whether a pair of terms of the query exhibits comparable semantic specificity. In flow diagram 300, a first term of the pair of terms is represented as term “A” and a second term of the pair of terms is represented as term “B”. If the first term does not exhibit comparable semantic specificity to the second term, then term A and term B may be ordered according to a relationship category indicative of incomparable semantic specificity at operation 312. As a non-limiting example, the term “annie” and the term “safari” exhibit an incomparable semantic specificity relationship, because there is no known relationship between the two terms without further context.

Alternatively, if the pair of terms exhibit comparable semantic specificity, then at operation 314, it may be judged whether the pair of terms exhibits similar semantic specificity. If the first term is semantically similar to the second term of the pair of terms, then term A and term B may be ordered according to a relationship category indicative of similar semantic specificity at operation 316. As a non-limiting example, the term “blue” and the term “green” exhibit similar semantic similarity, because both terms describe colors.

Alternatively, if the pair of terms does not exhibit similar semantic specificity, then it may be judged that one of the terms of the pair exhibits a greater semantic specificity than another term of the pair. For example, at operation 318 it may be judged whether term A is semantically more specific than term B. If term A is semantically more specific than term B, then term A and term B may be ordered according to a relationship category indicative of term A having a greater semantic specificity than term B at operation 320. In some implementations, term A may be associated with a greater weighting factor than term B. As a non-limiting example, the term “impala” may be judged to be semantically more specific than the term “wildlife”, whereby the term “impala” may be associated with a greater weighting factor than the term “wildlife”.

Alternatively, if term A is not semantically more specific than term B, then at operation 322, then it may be judged whether term B is semantically less specific than term A. If term A is semantically less specific than term B, then term A and term B may be ordered according to a relationship category indicative of term A having a lesser semantic specificity than term B at operation 324. For example, term B may be associated with a greater weighting factor than term A.

At operation 326, one or more of previously described operations 310-324 may be performed for each pair of terms of the query. As a non-limiting example, where a query comprises four terms, a pair-wise comparison may be performed for some or all of the six pairs of terms that may be formed by the query. It should be appreciated that relationship determination module 126 may comprise a multi-class classifier that may be deployed to determine the pair-wise relationships in a single pass.

At operation 328, the pair-wise comparison determined for each pair of terms of the query may be aggregated to obtain an ordering relationship for the plurality of terms of the query. For example, the ordering relationship may include weighting factors associated with the plurality of terms of the query in accordance with the relative semantic specificity of the terms. As previously described with reference to operation 216 of FIG. 2, these weighting factors may be referenced by a search engine when determining a result for the query.

Some portions of the detailed description are presented in terms of algorithms or symbolic representations of operations on binary digital signals stored within a memory of a specific apparatus or special purpose computing device or platform. In the context of this particular specification, the term specific apparatus, special purpose computing device, or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It is further recognized that all or part of the various devices and networks described herein, and the processes, methods, and operations as further described herein, may be implemented using or otherwise include hardware, firmware, software, or any combination thereof.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it will be appreciated that throughout this specification discussions utilizing terms such as “processing,” “computing,” “calculating,” “determining”, “performing” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain exemplary techniques have been described and shown herein using various methods, apparatuses, and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concepts described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
executing instructions by a special purpose computing apparatus to:
obtain one or more electrical digital signals representing a query, said query comprising a plurality of terms; and
apply to said query one or more electrical digital signals representative of a relationship indicative of semantic specificity between and/or among said plurality of terms.

2. The method of claim 1, and further comprising further executing said instructions by said special purpose computing apparatus to:
store in a memory one or more electrical digital signals representative of a result of application of said one or more electrical digital signals representative of said relationship to said one or more electrical digital signals representative of said query.

3. The method of claim 2, wherein said one or more electrical digital signals representative of said result indicates a hierarchical order of a plurality of result items.

4. The method of claim 2, wherein said one or more electrical digital signals representative of said result indicates at least one recommended term that exhibits a greater semantic specificity or a lesser semantic specificity than at least one term of the plurality of terms.

5. The method of claim 2, wherein said one or more electrical digital signals representative of said result indicates a graphical representation of said relationship indicative of semantic specificity between and/or among the plurality of terms.

6. The method of claim 1, and further comprising further executing said instructions by said special purpose computing apparatus to:
train a learning process on a domain of terms to learn a relationship indicative of semantic specificity between and/or among at least a portion of terms in the domain of terms; and
determine, based at least in part on said learned relationship, said relationship indicative of semantic specificity between and/or among said plurality of terms.

7. The method of claim 6, wherein the domain of terms is associated with a plurality of media content items; and
further comprising further executing said instructions by said special purpose computing apparatus to store in a memory one or more electrical digital signals representative of a result of application of said one or more electrical digital signals representative of said relationship to said one or more electrical digital signals representative of said query, wherein said result indicates an ordered list of a subset of the plurality of media content items.

8. The method of claim 2, and further comprising further executing said instructions by said special purpose computing apparatus to:
determine said relationship indicative of semantic specificity between and/or among said plurality of terms by identifying whether a first term of said plurality of terms exhibits a greater semantic specificity than a second term of said plurality of terms; and
increase an influence of said first term upon said result relative to an influence of said second term if said first term exhibits the greater semantic specificity than said second term of said plurality of terms.

9. The method of claim 1, and further comprising further executing said instructions by said special purpose computing apparatus to:
determine said relationship indicative of semantic specificity between and/or among said plurality of terms by identifying a pair-wise semantic specificity between each pair of terms of said plurality of terms.

10. The method of claim 1, and further comprising further executing said instructions by said special purpose computing apparatus to:
transmit to a user resource for presentation to a user one or more digital signals representative of a result of application of said one or more electrical digital signals representative of said relationship to said one or more electrical digital signals representative of said query.

11. An article comprising:
a storage medium comprising machine-readable instructions stored thereon which, in response to being executed by a processor, direct said processor to:
obtain a query comprising a plurality of terms; and
apply to said query a relationship indicative of semantic specificity between and/or among said plurality of terms.

12. The article of claim 11, wherein said instructions, in response to being executed by said processor, further direct said processor to:
store in a memory a result of application of said relationship to said query.

13. The article of claim 12, wherein said result indicates a hierarchical order of a plurality of result items.

14. The article of claim 12, wherein said relationship indicative of semantic specificity between and/or among said plurality of terms includes a pair-wise semantic specificity between each pair of terms of said plurality of terms; and
wherein said instructions, in response to being executed by said processor, further direct said processor to:
for each pair of terms of said plurality of terms, determine said pair-wise semantic specificity by identifying whether a first term of said pair exhibits a greater semantic specificity than a second term of said pair; and
increase an influence of said first term upon said result relative to an influence of said second term if said first term exhibits the greater semantic specificity than said second term.

15. The article of claim 11, wherein said instructions, in response to being executed by said processor, further direct said processor to:
train a learning process on a domain of terms to learn a relationship indicative of semantic specificity between and/or among at least a portion of terms in the domain of terms; and
determine, based at least in part on said learned relationship, said relationship indicative of semantic specificity between and/or among said plurality of terms.

16. An apparatus comprising:
a computing platform comprising:
a communication interface to receive electrical digital signals representative of information from a digital electronic communication network; and
one or more processors programmed with instructions to:
obtain one or more electrical digital signals received at said communication interface from said digital electronic communication network and representing a query, said query comprising a plurality of terms; and
apply to said query one or more electrical digital signals representative of a relationship indicative of semantic specificity between and/or among said plurality of terms.

17. The apparatus of claim 16, wherein said computing platform further comprises a memory adapted to store one or more electrical digital signals; and
wherein said one or more processors are further programmed with instructions to:
store in said memory one or more electrical digital signals representative of a result of application of said one or more electrical digital signals representative of said relationship to said one or more electrical digital signals representative of said query.

18. The apparatus of claim 17, wherein said one or more electrical digital signals representative of said result indicates a hierarchical order of a plurality of result items.

19. The apparatus of claim 17, wherein said relationship indicative of semantic specificity between and/or among said plurality of terms includes a pair-wise semantic specificity between each pair of terms of said plurality of terms; and
wherein said one or more processors are further programmed with instructions to:
for each pair of terms of said plurality of terms, determine said pair-wise semantic specificity by identifying whether a first term of said pair exhibits a greater semantic specificity than a second term of said pair; and
increase an influence of said first term upon said result relative to an influence of said second term if said first term exhibits the greater semantic specificity than said second term.

20. The apparatus of claim 16, wherein said one or more processors are further programmed with instructions to:
train a learning process on a domain of terms to learn a relationship indicative of semantic specificity between and/or among at least a portion of terms in the domain of terms; and
determine, based at least in part on said learned relationship, said relationship indicative of semantic specificity between and/or among said plurality of terms.
